(19) United States
(12) Patent Application Publication
(10) Pub. No.: US 2008/0155886 A1
(43) Pub. Date: Jul. 3, 2008

(54) Insect-Repellant Utensil and Process For Production Thereof

(76) Inventors: Norimasa Okuda, Osaka (JP); Hidetoshi Fukuo, Osaka (JP); Masahiro Yasunaga, Osaka (JP); Makoto Hirotani, Osaka (JP); Tomonori Iwasaki, Hyogo (JP)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/884,215

(22) PCT Filed: Feb. 17, 2006
(86) PCT No.: PCT/JP06/02840

§ 371 Date: Aug. 10, 2007

(30) Foreign Application Priority Data
Feb. 18, 2005 (JP) 2005-042466

(51) Int. Cl. A01M 3/02; A01N 25/34; B32B 38/00; B32B 27/18

(52) U.S. Cl. 43/132.1; 424/409; 156/256; 156/278

(57) ABSTRACT

An insect repellent device and a method for manufacturing the same, the insect repellent device containing an active ingredient being volatilizable at normal temperature. An insect repellent device adapted to volatilize an active ingredient contained in an insect controlling agent by waving motion includes a frame and a face-forming member, which is fixed to the frame. The face-forming member has on its entire surface a coating layer formed by surface treatment such as varnishing. The coating layer holds the insect controlling agent containing the active ingredient being volatilizable at normal temperature. The ingredient volatilizes from the coating layer, thereby exerting an effect of an insect-repellent. The coating layer is formed by the surface treatment using a surface treatment agent containing the insect controlling agent, which has been prepared by adding the insect controlling agent to a surface treatment agent.

### BACKGROUND OF THE INVENTION

1. Field of the Invention

The present invention relates to insect repellent devices and methods for manufacturing the same. More particularly, it relates to an insect repellent device holding an insect controlling agent (an insecticidal or insect repellent agent) that contains an active ingredient being volatilizable at normal temperature and allowing a face-forming member to volatilize the active ingredient contained in the agent, the device being adapted to efficiently volatilize the ingredient and easy to be manufactured, and to a method for manufacturing the same.

2. Description of Related Art

Insect repellent devices such as a device for volatilizing an active ingredient contained in an insect controlling agent are conventionally used so as to keep repellently harmful insects such as a mosquito away. However, many of such the devices are designed to volatilize the ingredient by heating, requiring a separate heat source.

On the other hand, the patent documents 1 and 2 each discloses such an insect repellent device of a fan-like shape as volatilizing an active ingredient contained in an insect controlling agent by waving the device by a human hand.

Patent Document 1: JP 62-111419 U

Patent Document 2: JP 5-21676 U

An insect repellent device disclosed in the patent document 1 is a fan using a thermoplastic resin film layer containing an insect controlling agent containing a volatile active ingredient. The device disclosed in the patent document 1 is designed to expose the thermoplastic resin film in being used, so as to volatilize the active ingredient contained in the agent to atmospheric air directly from the film.

An insect repellent device disclosed in the patent document 2 is a fan provided with surface-forming layers at its both sides, between which an insect controlling agent-containing layer is sandwiched.

The device disclosed in the patent document 2 volatilizes an active ingredient contained in the agent mainly from the periphery of the fan.

### SUMMARY OF THE INVENTION

### Problems To Be Solved By the Invention

In the insect repellent device disclosed in the patent document 1, the insect controlling agent is absorbed in a film layer or the like, from which the active ingredient contained in the agent is directly volatilized to the air. That has an advantage in high volatilization efficiency. However, the device disclosed in the patent document 1 has a disadvantage in stickiness due to potential insect controlling agent coming out to a surface of the fan.

Further, the device disclosed in the patent document 1 is thick in total because a film and the like are adhered to at least one surface thereof. Thus, the fan to which the film and the like are adhered is hardened and less flexible, rendering the necessary air-blowing ineffective.

Still further, the device disclosed in the patent document 1 is thick and heavy, resulting in uncomfortable use.

In the insect repellent device disclosed in the patent document 2, the surface-forming layers are formed at its both sides, between which the insect controlling agent-containing layer is sandwiched, offering no stickiness on a surface thereof. However, an available exposed surface of the insect controlling agent is limited to the periphery of the fan, rendering less volatilization efficiency of the active ingredient contained in the agent.

Further, the device disclosed in the patent document 2, as well as the above-mentioned device disclosed in the patent document 1, is also thick in total, hard, and less flexible, rendering the necessary air-blowing ineffective. Still further, the device is heavy, resulting in uncomfortable use.

Further, it must be avoided to spend an excessive amount of money on manufacturing fans because the fans are often distributed for free as sales promotional items recently. However, the cost of manufacturing of such the fan is higher than that of manufacturing of a normal fan because it requires a special process for holding the insect controlling agent on the fan, such as adhering of a film, to manufacture the conventional fans described above that hold the agent thereon. Existing manufacturing facilities cannot deal with such the process, so that new facilities are needed, ever increasing the manufacturing cost.

It is therefore an object of the present invention made in view of the problems and drawbacks described above to provide an advanced insect repellent device that holds an insect controlling agent containing an active ingredient being volatilizable at normal temperature and that volatilizes the ingredient contained in the agent by waving or fanning, the device being adapted to efficiently volatilize the ingredient and to be manufactured readily and at low cost. Further, it is another object of the present invention to provide a method for manufacturing the insect repellent device adapted to achieve a similar object.

### Means To Solve the Problem

The inventors reviewed structure of fans in existence and manufacturing processes thereof in order to solve the above-mentioned problems and drawbacks.

As for structure of a fan, a fan is generally manufactured by adhering a frame and papers in such a manner that the papers sandwich the fan from both sides. In most case in which some sort of graphic pattern is printed on a fan, it is necessary to print a desired pattern on the papers before adhesion of the papers to the frame. Further, surface-protection treatment such as varnishing is performed so as to protect the printed pattern and to give elasticity to the papers. Then, the papers on which the printing and the surface-protection treatment are performed are adhered to the frame.

In some case, the surface-protection treatment is performed after adhesion of the papers to the frame.

Thus, the inventors conceived the idea to make the papers to hold an insect controlling agent simultaneously with the varnishing. Specifically, a manufacturing process, which is conceived by the inventors, is a step of containing an insect controlling agent in a varnish and performing surface treatment using the varnish.

According to this step, an insect repellent device is manufactured by the same processes as those of manufacturing the usual fans. A manufacturing device in existence can be also used.

The varnish can be hardened, so that a varnish layer is less sticky. Further, a layer that is protection-treated by the varnish exists in the fans in existence, and the insect repellent device of this structure has the substantially same thickness as the fans in existence. Thus, the insect repellent device manufactured according to the above-mentioned process is light and not sticky, being convenient for use.

An aspect of the invention invented by the above-mentioned background is an insect repellent device adapted to repel insects by being held and waved by hand, including a frame and at least one face-forming member arranged on at least one surface of the frame, wherein the face-forming member has at least one exposed surface exposed to atmospheric air, the at least one exposed surface having a coating layer, and the coating layer holding an insect controlling agent containing an active ingredient being volatilizable at normal temperature and being effective in insect-repellent.

The insect repellent device of the present aspect is designed to volatilize the active ingredient contained in the insect controlling agent by means of the face-forming member and includes the frame and the face-forming member arranged on the frame. The face-forming member has on its surface the coating layer, which holds the insect controlling agent. The agent contains the active ingredient being volatilizable at normal temperature. The device of the present aspect dispenses with a material such as a film for holding the agent, thereby maintaining flexibility of the face-forming member. That facilitates waving of the device and achieves volatilization of the active ingredient more efficiently. Further, the device of the present aspect does not require a separate process such as a film application because being manufactured by surface treatment, for example, using a surface treatment liquid containing an insect controlling agent, which has been prepared by adding the agent to a surface treatment liquid. Consequently, the device of the present aspect is easy and inexpensive to be manufactured. Herein, the term “insect controlling agent” includes both an insecticidal agent and an insect repellent agent.

In the above-mentioned aspect, the coating layer is preferably formed by surface-protection treatment.

The coating layer is preferably a varnish layer.

The frame may have a frame body and a handle.

Specifically, the device of the present aspect has such a structure as a foldable or unfoldable fan. The frame has the frame body and the handle, the handle being held by hand and moved back and forth to wave the face-forming member, so as to blow air.

The device of the present aspect has the handle, so as to be readily held and waved. That achieves volatilization of the active ingredient contained in the agent more efficiently.

The face-forming member is preferably made of paper.

Such a configuration facilitates formation of the coating layer on the face-forming member and holds the agent more readily.

It is recommended that the active ingredient contained in the insect controlling agent has a vapor pressure at 25 degrees centigrade by Donovan method within a range of 1.33×10⁻⁴ to 6.67×10⁻¹ Pa (1×10⁻⁶ to 5×10⁻³ mmHg).

It is also recommended that the active ingredient contained in the insect controlling agent is a pyrethroid compound.

Such a configuration ensures an insect repellent effect.

In the case that the active ingredient contained in the insect controlling agent is a pyrethroid compound and further has a vapor pressure at 25 degrees centigrade by Donovan method within a range of 1.33×10⁻⁴ to 6.67×10⁻¹ Pa (1×10⁻⁶ to 5×10⁻³ mmHg), 1 mg or more of the agent held in the entire device exerts some effect. It is not necessary to hold over 1000 mg.

As another additional component, the device may hold a fragrant substance containing an active ingredient being volatilizable at normal temperature.

The device of this aspect holds the fragrant substance, so that waving of the device gives off a good smell and feels good.

The fragrant substance preferably has a period of time of being effectively volatilizable in conformity with that of the active ingredient contained in the insect controlling agent.

The device of this aspect allows users to check a remaining amount of the active ingredient contained in the agent by fragrant strength of the fragrant substance as an indication because the active ingredient of the fragrant substance volatilizes in a way comparable to the active ingredient contained in the agent.

At least the face-forming member is preferably contained and hermetically sealed in a container made of a material impermeable to the active ingredient contained in the insect controlling agent. The entire device may be hermetically sealed in the container.

Herein, the container includes conceptually a bag made of resin sheet or resin film.

Such a configuration controls volatilization of the active ingredient contained in the agent before use of the device.

The face-forming member may be made of paper and printed in ink, the ink holding an insect controlling agent containing an active ingredient being volatilizable at normal temperature and being effective in insect-repellent.

The device of this aspect holds the insect controlling agent not only in the exposed coating layer but also in a printed portion therewithin. That holds a large amount of the agent and exerts its effect for a long time.

Another aspect further recommended in the invention is an insect repellent device adapted to repel insects by being held and waved by hand, including a frame and at least one face-forming member arranged on at least one surface of the frame, wherein the face-forming member has at least one exposed surface exposed to atmospheric air, the at least one exposed surface having a coating layer, the coating layer holding an insect controlling agent containing an active ingredient being volatilizable at normal temperature and being effective in insect-repellent, the active ingredient being a pyrethroid compound having a vapor pressure at 25 degrees centigrade by Donovan method within a range of 1.33×10⁻⁴ to 6.67×10⁻¹ Pa (1×10⁻⁶to 5×10⁻¹ mmHg), and the device holding the agent within a range of 1 to 1000 mg in total.

Still another aspect further recommended in the invention is an insect repellent device adapted to repel insects by being held and waved by hand, including a frame having a frame body and a handle and at least one face-forming member made of paper, printed in ink, and arranged on at least one surface of the frame, wherein the face-forming member has at least one exposed surface exposed to atmospheric air, the at least one exposed surface having a varnish layer, the varnish layer holding an insect controlling agent containing an active ingredient being volatilizable at normal temperature and being effective in insect-repellent, the active ingredient being a pyrethroid compound having a vapor pressure at 25 degrees centigrade by Donovan method within a range of 1.33×10⁻⁴ to 6.67×10⁻¹ Pa (1×10⁻⁶ to 5×10⁻³ mmHg), the device holding the agent within a range of 1 to 1000 mg in total, and at least the face-forming member being contained and hermetically sealed in a bag made of a material impermeable to the active ingredient contained in the agent.

Yet another aspect of the present invention is a method for manufacturing either of the above-mentioned insect repellent devices, wherein the coating layer is formed by application of treatment liquid to the face-forming member, the treatment liquid containing the insect controlling agent.

This aspect of the present invention relates to the method for manufacturing an insect repellent device that is made up by fixing a face-forming member holding an insect controlling agent to a frame and that is adapted to volatilize an active ingredient contained in the agent by waving the device. Further, in the method of this aspect, the coating layer is formed by applying surface treatment to the face-forming member using the treatment liquid in which the insect controlling agent is solved or dispersed in a surface treatment agent such as a varnish, so as to hold the insect controlling agent in the face-forming member. The method of this aspect uses the treatment liquid containing the insect controlling agent, so that the insect controlling agent is held in the face-forming member simultaneously with the surface treatment. Specifically, only the use of the surface treatment liquid containing the insect controlling agent instead of the usual surface treatment liquid manufactures the insect repellent device, dispensing with new facilities and special process such as a film application. Consequently, the insect repellent device is manufactured extremely readily and inexpensively.

More specific aspect is a method for manufacturing an insect repellent device of a foldable or unfoldable fan shape constituted by a frame having a frame body and a handle, including the step of adhering a face-forming member to the frame and applying a varnish to a surface of the face-forming member before or after the step of adhering the face-forming member to the frame, the varnish containing an insect controlling agent containing an active ingredient being volatilizable at normal temperature.

In the case that the face-forming member is made by cutting paper into a predetermined shape, the step of applying the varnish is performed by applying the varnish containing the insect controlling agent to the paper before cutting.

The insect controlling agent is the same as the foregoing aspects, and it is preferable that the active ingredient is a pyrethroid compound having a vapor pressure at 25 degrees centigrade by Donovan method within a range of 1.33×10⁻⁴ to 6.67×10⁻¹ Pa (1×10⁻⁶ to 5×10⁻³ mmHg) and that the device has a concentration of the agent and a thickness of the varnish adjusted so as to hold the agent within a range of 1 to 1000 mg in total.

It is preferable that the method further includes the step of storing the device in a bag made of a material impermeable to the active ingredient contained in the agent.

### Advantageous Effect of the Invention

The insect repellent device of the present invention holds the insect controlling agent in the coating layer formed on the face-forming member. That makes the device light and flexible, facilitating waving of the device. That also makes it easy to manufacture the device.

The method for manufacturing an insect repellent device of the present invention performs the surface treatment to the face-forming member and simultaneously allows the face-forming member to hold the insect controlling agent, thereby manufacturing the device readily and inexpensively.

### BRIEF DESCRIPTION OF THE DRAWINGS

FIG. 1 is a front view of an insect repellent device of an embodiment of the present invention;

FIG. 2 is a front view of a frame for making up the insect repellent device of the embodiment of the present invention;

FIG. 3 is a partly enlarged sectional view of the insect repellent device taken along line A-A of FIG. 1;

FIG. 4 is a front view of an insect repellent device of another embodiment of the present invention; and

FIG. 5 is a front view showing a hermitically-sealed insect repellent device of the embodiment of the present invention.

### BEST MODE FOR CARRYING OUT THE INVENTION

Now, a best mode for carrying out the present invention will be described below in detail, making reference to the accompanying drawings.

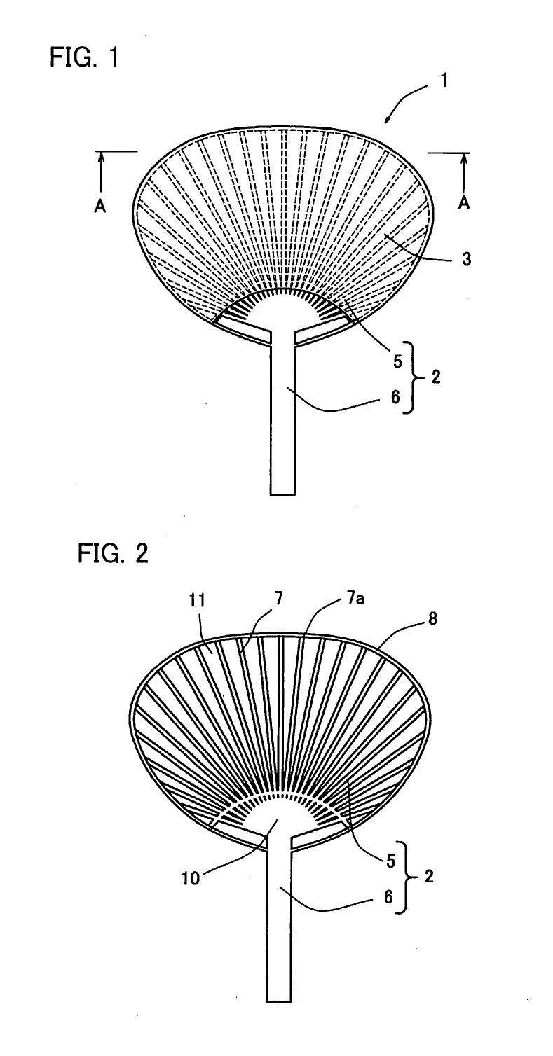

One embodiment of an insect repellent device of the present invention includes a face-forming member fixed to a frame. The face-forming member has on its surface a coating layer formed by surface treatment and holding an insect controlling agent containing an active ingredient being volatilizable at normal temperature. An example of the present embodiment will be described below, making reference to FIGS. 1 and 2. An insect repellent device 1 shown in FIG. 1 is adapted to volatilize an active ingredient contained in an insect controlling agent by waving motion and is constituted by a frame 2 and at least one face-forming member 3. The face-forming member 3 is fixed to the frame 2. The frame 2 is constituted by a frame body 5 and a handle 6. The handle 6 is of a stick shape and has a size grippable by hand. As described below, the insect repellent device 1 can be used by the waving motion with the handle 6 held and waved by hand.

As shown in FIG. 2, the frame body 5 has a plurality of linear parts 7 and a peripheral frame part 8. The linear parts 7 extend linearly and radially from a base part 10 in different directions, being in the same plane. Thus, as described below, the face-forming member 3 is fixed to the frame body 5 of the frame 2 so as to be planate.

The peripheral frame part 8 makes substantially a circuit of a periphery of the frame body 5 and is continuous with edges 7a of the linear parts 7. A gap 11 is formed between each neighboring pair of the linear parts 7. The handle 6 is continuous with the frame body 5 adjacent to the base part 10.

The frame 2 is made of polypropylene, but may be made of another material. A resin material such as polyamide, polyethylene terephthalate, polystyrene, acrylonitrile butadiene styrene copolymer, polyoxymethylene, and biodegradable resins may be used as the material. Further, paper or a wooden material such as bamboo may be used.

The face-forming member 3 is made of paper and of substantially the same shape as the frame body 5. There are provided two face-forming members 3, which are fixed with an adhesive agent so as to sandwich the frame body 5 of the frame 2 from both sides thereof. Therefore, the linear parts 7 and the peripheral frame part 8 are covered with the face-forming members 3, so as to be invisible from outside. Herein, a material of the face-forming members 3 is not limited only if the member 3 can be surface-treated and hold the insect controlling agent, and may be other than paper. The face-forming members 3 each have an area, in conformity with that of a normal fan, of about 15×15 cm to 20×20 cm.

A picture or a letter may be printed on a face-forming member 3, as well as on the conventional fan.

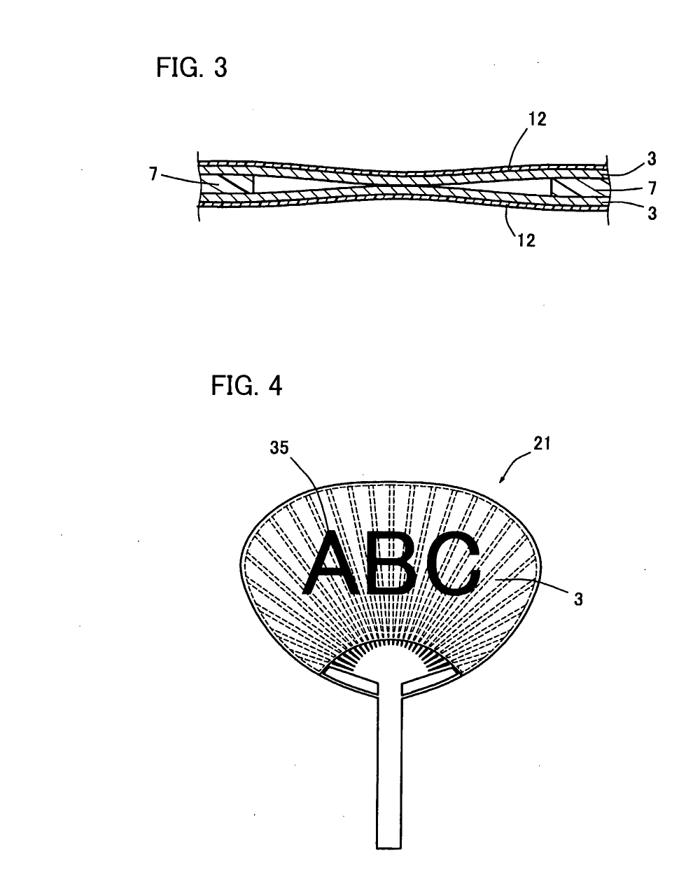

As shown in FIG. 3, the face-forming members 3 each have on its entire surface a coating layer 12 formed by surface treatment. Specifically, the coating layer 12 is formed by surface-protection treatment, and more specifically by a hardened varnish. The coating layer 12 covers all over one surface of each of the face-forming members 3 and has the same area as the face-forming member 3. In the present embodiment, the face-forming members 3 are provided at both sides of the linear parts 7. Thus, the coating layers 12 are provided at the outer surfaces of the face-forming members 3.

In the case that a printing such as a picture or a letter is on the face-forming member 3, the coating layer 12 is provided over the printing.

As shown in FIG. 3, the coating layers 12 each are fixed in a substantially uniform thickness to the surface of the face-forming member 3 made of paper. Herein, in FIG. 3, the coating layers 12 each are illustrated thicker than the real thing to facilitate understanding. The coating layer 12 is quite thinner than a film for use in the conventional insect repellent device. That maintains flexibility of the face-forming member 3, which is suitable for waving the insect repellent device 1.

The coating layer 12 is formed by the surface treatment, and more specifically by varnishing. The insect controlling agent containing the active ingredient being volatilizable at normal temperature is held in the coating layer 12 with mixed with the varnish, so that the active ingredient contained in the agent volatilizes from the coating layer 12, thereby exerting a predetermined effect. The varnish for use in the device 1 is not limited to a special kind thereof, and a varnish such as UV varnish, water-based varnish, and oil-based varnish can be used. A surface treatment agent other than a varnish is applicable only if the treatment agent is capable of holding the insect controlling agent.

The coating layer 12 holds an insect controlling agent containing a pyrethroid insecticidal compound as the one containing the active ingredient being volatilizable at normal temperature. Preferable examples of the pyrethroid insecticidal compound, which is the active ingredient of the insect controlling agent, include a 2,3,5,6-tetrafluoro-4-benzyl-2,2-dimethylcyclopropanecarboxylate type pyrethroid insecticidal compound such as:

2,3,5,6-tetrafluorobenzyl(1R)-trans-3-(2,2-dichlorovinyl)-2,2-dimethyl cyclopropanecarboxylate (common name: transfluthrin);

2,3,5,6-tetrafluoro-4-methoxymethylbenzyl(1R)-trans-3-(1-propenyl-(E/Z=1/8))-2,2-dimethylcyclopropanecarboxylate;

2,3,5,6-tetrafluoro-4-methoxymethylbenzyl(1R)-trans-3-(2-metyl-1-propenyl)-2,2-dimethylcyclopropanecarboxylate;

2,3,5,6-tetrafluoro-4-methoxymethylbenzyl-2,2,3,3-tetramethylcyclopropanecarboxylate; and

2,3,5,6-tetrafluoro-4-methylbenzyl(1R)-trans-3-(1-propenyl(E/Z=1/8))-2,2-dimethylcyclopropanecarboxylate.

The examples also include a pyrethroid insecticidal compound such as:

1-etynyl_{z}-2-methyl-2-pentenyl-3-(2-chloro-2-fluorovinyl)-2,2-dimethyl cyclopropane-1-carboxylate;

2,3,5,6-tetrafluoro-4-methylbenzyl-3-(2-metyl-1-propenyl)-2,2-dimethylcyclopropanecarboxylate;

2,3,5,6-tetrafluoro-4-methylbenzyl-3-(2-chloro-2-fluorovinyl)-2,2-dimethylcyclopropanecarboxylate;

2,3,5,6-tetrafluoro-4-methylbenzyl-3-(1-propenyl)-2,2-dimethylcyclopropanecarboxylate;

1-etynyl-2-methyl-2-pentenyl(1R)-3-(2-metyl-1-propenyl)-2,2-dimethylcyclopropane-carboxylate(common name: empenthrin);

1-etynyl-2-methyl-2-pentenyl-3-(2-metyl-1-propenyl)-2,2-dimethylcyclopropanecarboxylate; and

1-etynyl-2-methyl-2-pentenyl-3-(2,2-dichlorovinyl)-2,2-dimethylcyclopropanecarboxylate.

Other insecticidal compounds include 2,2-dichlorovinyl dimethyl phosphate, N,N-diethyl-m-toluamide, and caran-3,4-diol.

The use of the insect controlling agent containing the active ingredient as described above controls insect pests by means of the insect repellent device of the present embodiment. Examples of the controllable insect pests specifically include various kinds of harmful insects, especially harmful flying insect pests such as dipterous insects including Culex such as Culex pipiens pallens (common house mosquito) and Culex tritaeniorhynchus Giles (small house mosquito); Aedes such as Aedes aegypti (yellow fever mosquito) and Aedes albopictus (Skuse) (tiger mosquito); Anopheles such as Anopheles sinensis; Chironomidae; Muscidae such as Musca domestica (housefly), Muscina stabulans (false stable fly) and Fannia canicularis (lesser housefly); Calliphoridae (greenbottle flies); Sarcophagidae (flesh flies), Drosophila (fruit flies); Phlebotominae; Phoridae; Tabanidae (gadflies); Simuliidae (black-flies); Stomoxys (stable flies); and Ceratopogonidae (biting midges); and hymenopterous insects including Vespidae (hornets); Chrysidoidea; and Enthredinidae such as Athalia rosae ruficomis.

Most of these active ingredients are liquid at normal temperature and is directly applicable as an insect controlling agent. Preferably, the active ingredient for use in the present invention has a vapor pressure at 25 degrees centigrade by Donovan method within a range of 1.33×10⁻⁴ to 6.67×10⁻¹ Pa (1×10⁻⁶ to 5×10⁻³ mmHg). Herein, the Donovan method is a method reported by Mr. Stephen F. Donovan in “New method for estimating vapor pressure by the use of gas chromatography: Journal of Chromatography A. 749 (1996) 123-129.

An amount of the insect controlling agent per one insect repellent device 1 as shown in FIG. 1 depends on a size of the device 1, but is within a range of 1 to 1000 mg, and preferably within a range of 2 to 200 mg.

The insect repellent device 1 has the handle 6, so that holding of the handle 6 by hand facilitates waving of the device 1. Such the waving volatilizes the active ingredient contained in the insect controlling agent from the device 1 more efficiently.

The face-forming member 3 may hold a fragrant substance containing an active ingredient being volatilizable at normal temperature with the insect controlling agent. Examples of the active ingredient contained in the fragrant substance include a terpene hydrocarbon such as myrcene, carene, limonene, pinene, terpinene, camphene, pisapolene, warcumene, cantharen, camphorene, and mirene, a terpene alcohol such as citronellol, geraniol, nerol, linalool, menthol, bomeol, famesenol, nerolidol, cadinol, phytol, manool, and hinokiol, a terpene aldehyde or ketone such as citronellal, citral, cafranal, ionone, menthone, irone, cyperone, zerumbone, and sugiol, an aromatic compound such as phenylethyl alcohol, phenylacetaldehyde, heliotropin, anisaldehyde, cinnamaldehyde, musk xylene, and musk ketone, and a carboxylic acid such as butyl acetate, ethyl acetate, methyl salicylate, ethyl caproate, caproic acid, ethyl butyrate, cyclohexyl butyrate, ethyl propionate, and benzyl propionate, or ester of any of the carboxylic acids.

A content of the fragrant substance may be at discretion, but adjustment of a period of time of effective volatilization of the fragrant substance to that of effective volatilization of the active ingredient contained in the insect controlling agent allows users to check a remaining amount of the active ingredient contained in the agent by fragrant strength of the fragrant substance as an indication.

The device can be also used as a device for releasing fragrance after losing the insect repellent effect by lengthening an effective period of the fragrant substance.

Further, as described above, a design of some sort is generally printed on fans. Thus, a print ink may also hold the insect controlling agent containing the above-mentioned active ingredient being volatilizable at normal temperature.

Another embodiment of an insect repellent device with holding an insect controlling agent in a printed portion is shown in FIG. 4.

As shown in FIG. 4, in an insect repellent device 21 of the present embodiment, a surface of a face-forming member 3 made of paper is printed with a print character 35 composed of letters “ABC”. The print character 35 is printed by an offset printing and visualized letters are printed by an appropriate offset ink. The print character 35 of the printed “ABC” holds an agent mixed with the offset ink and containing an active ingredient being volatilizable at normal temperature.

In the present embodiment, as well as the foregoing embodiment, a varnish coating layer (not shown) is formed on the surface of the face-forming member 3, the coating layer also holding an insect controlling agent containing an active ingredient being volatilizable at normal temperature.

In the insect repellent device 21 of the present embodiment, as well as the foregoing embodiment, waving of the device 21 volatilizes the active ingredient from the varnish coating layer (not shown). The present embodiment holds the agent not only in the varnish layer but also in the printed character 35, so as to have a high content of the held agent and be effectively used for a long period of time.

The agent held in the printed character 35 may be the similar agent to that held in the coating layer 12 of the insect repellent device 1 of the foregoing embodiment. Further, a vapor pressure of the active ingredient contained in the agent may be within the similar range to that in the foregoing embodiment.

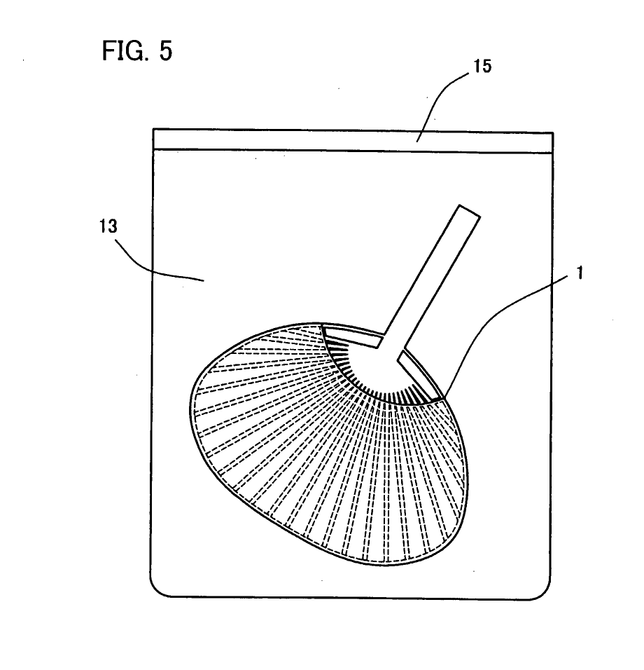

In the insect repellent devices 1 and 21, it is preferable to protect the active ingredient from volatilizing before use. A hermetically-sealed package is possible to do so, for example. Specifically, the devices 1 and 21 each are contained and hermetically sealed in a container made of a material impermeable to the ingredient, which is opened just before use, so that the devices 1 and 21 each are taken out of the container and used. The device 1 shown in FIG. 5 is packed by being contained in a transparent bag (container) 13 made of nylon and hermetically sealed at a portion 15 to be opened on the top of the bag 13. When to be used, the device 1 is taken out of the bag 13 by opening the portion 15.

In FIG. 5, the whole device 1 is contained in the bag (container) 13, but only a part except the handle 6 of the device 1, i.e., corresponding to the face-forming member 3, may be contained and hermetically sealed in the bag 13.

A method for protecting the ingredient from volatilizing by means of other than the hermetically-sealed package includes provision of an easily-removable diffusion-preventing part so as to cover the coating layer 12, the part being removed to use the device just before use.

In the devices 1 and 21 each, the surface of the coating layer 12 has dry touch without being sticky by the insect controlling agent. Consequently, that leads to a lower risk of sticking the agent containing the active ingredient of a high concentration to a user's skin. Further, the ingredient volatilizes at moderate speed, so as to be favorable in effectiveness and continuousness. That would be because the active ingredient is dispersed appropriately in the hardened varnish to form the coating layer 12. Herein, in the device 1 of the present embodiment, adjustment of a content of the agent in the varnish adjusts a volatilizing amount of the ingredient.

Now, a method for manufacturing the insect repellent device of the present invention will be described. One embodiment of the method includes the five steps as follows:
(1) a step of providing a frame;
(2) a step of providing a face-forming member;
(3) a step of adding an insect controlling agent containing an active ingredient being volatilizable at normal temperature to a surface treatment agent, so as to prepare a surface treatment agent containing the insect controlling agent;
(4) a step of performing surface treatment onto the face-forming member by using the surface treatment agent, so as to hold the insect controlling agent in the face-forming member; and
(5) a step of fixing the face-forming member holding the insect controlling agent to the frame.
Among these steps, the steps of (1), (2), and (3) may be performed, not limited to the orders.

Further, any step other than these steps can be included. A step of drawing a design on the surface of the face-forming member 3 by means such as a print or a hand-writing may be included.

As an example of the method for manufacturing the device of the present embodiment, a method for manufacturing the insect repellent device 1 shown in FIG. 1 will be described in detail according to the steps. In the step (1) of “providing a frame,” a polypropylene resin molding, for example, is provided so as to make the frame 2. A material other than polypropylene such as other resin moldings or wooden works may be provided. In the step (2) of “providing a face-forming member,” a paper capable of being surface-treated is provided so as to make the face-forming member 3. A material other than paper may be used only if being capable of being surface-treated. Herein, it is not necessary to cut the face-forming member 3 in accordance with a shape of the frame 2 at this moment. It is enough if the member 3 is cut, for example, before the step (5). A large-area paper to which a varnish containing the insect controlling agent is applied may be cut into a predetermined shape before adhesion of the paper to the frame 2.

In the step (3) of “adding an insect controlling agent containing an active ingredient being volatilizable at normal temperature to a surface treatment agent, so as to prepare a surface treatment agent containing the insect controlling agent,” a varnish is used as the surface treatment agent. The varnish to be used is not limited to a special kind thereof, and a varnish such as UV varnish, water-based varnish, and oil-based varnish can be used. A surface treatment agent other than a varnish is applicable only if the agent is capable of forming the coating layer 12 and holding the insect controlling agent after hardening of the surface treatment agent. An amount of the insect controlling agent added to the varnish is enough only if the amount allows the active ingredient volatilizing from the device 1 to exert its effect and ensure the surface treatment. When the insect controlling agent is added to the surface treatment agent, the former agent can be added straight, but may be solved with a proper solvent and added to the latter agent, so as to prepare the surface treatment agent containing the insect controlling agent.

In the step (3), a fragrant substance being volatilizable at normal temperature may be added in addition to the insect controlling agent, thereby manufacturing the insect repellent device that allows users to check a remaining amount of the active ingredient contained in the insect controlling agent by fragrant strength of the fragrant substance as an indication.

A content of the fragrant substance is adjusted so that a period of time of effective volatilization of the fragrant substance corresponds to that of effective volatilization of the active ingredient.

Herein, in the present embodiment, the fragrant substance is mixed with the varnish, so that surfaces from which the active ingredient is volatilized and from which the fragrant substance is volatilized are the same. However, one surface of the device may have a layer containing the insect controlling agent and the other surface thereof may have a layer containing the fragrant substance. Further, the fragrant substance may be contained in a particular portion of the surface.

In the step (4) of “performing surface treatment onto the face-forming member by using the surface treatment agent, so as to hold the insect controlling agent in the face-forming member,” the surface treatment agent containing the insect controlling agent (or the varnish containing the insect controlling agent) having been prepared in the step (3) is used to perform surface treatment by varnishing to the entire surface of the face-forming member 3. Hardening of the varnish forms the coating layer 12, in which the active ingredient is uniformly dispersed and held. The varnishing may be performed by an in-line system or an off-line system, but, in the case of printing on the face-forming member 3, is preferably performed in an in-line system following the printing. For example, the printing is performed in a printing factory, following up with the varnishing in the same factory. A sheet (face-forming member 3) having been printed and varnished is carried to a fan manufacturing factory to carry out post-processes.

One treatment such as varnishing is generally enough, but a plurality of treatments may be performed in order to hold a larger amount of the insect controlling agent. Specifically, recoating of the varnish by a plurality of repetitions of the varnishing forms a thick layer formed by surface treatment, so that a larger amount of the insect controlling agent is held therein.

In the step (5) of “fixing the face-forming member holding the insect controlling agent to the frame,” the face-forming member 3 and the frame 2 are fixed to each other by an adhesive bond. Specifically, the face-forming member 3, which has been cut into a shape of the frame 2 in advance, and the frame 2 are lapped via an adhesive bond and subjected to a presser to adhere them by pressing.

After the step (5), a step of packing and hermetically sealing the insect repellent device 1 may be performed. For example, as shown in FIG. 5, the device 1 is contained in the transparent bag 13 made of vinyl and hermetically sealed at the portion 15 to be opened on the top of the bag 13.

In the case of manufacturing the insect repellent device 21 holding the agent also in the print character 35, as shown in FIG. 4, prior to the surface treatment using the surface treatment agent containing the insect controlling agent (or varnish containing the insect controlling agent), the print character 35 is printed on the face-forming member 3.

An agent containing an active ingredient being volatilizable at normal temperature is added to an ink to be used for printing in advance.

As to the ink, a proper ink to print may be appropriately selected. In the case of off-set printing, for example, the ink may be appropriately selected from the kinds belonging to so-called offset inks and used.

In the step of printing on the face-forming member 3 using the ink containing the agent so as to hold the agent in the print character 35, a letter or a figure is printed by offset printing. At this time, the ink mixed with the agent adheres to the face-forming member 3, thereby holding the agent in the print character 35. The offset printing can be performed in a usual way using the ink containing the agent instead of a usual ink.

In the above-mentioned embodiment, the step (5) follows the step (4). Such a way is recommended for manufacturing of the fan-shape insect repellent device 1 in one factory, but formation of the fan and addition of an insect repellent function to the fan can be performed in separate factories. In this case, the step (4) follows the step (5).

Specifically, a company or a person asks a manufacturer of a foldable or unfoldable fan to manufacture a device such as a fan on which his favorite graphic pattern is printed and takes the manufactured device in a “factory for adding the insect repellent function.” The asked “factory” applies the surface treatment agent containing the insect controlling agent (or varnish containing the insect controlling agent) to the device having been taken therein. Thereby, the insect repellent function is added to a usual device such as a fan.

The present invention is described in detail more specifically below by examples, but is not limited thereto.

### EXAMPLES

### 1. Preparation of A Varnish Containing An Insect Controlling Agent

2,3,5,6-tetrafluoro-4-methoxymethylbenzyl(1R)-trans-3-(1-propenyl (E/Z=1/8))-2,2-dimethylcyclopropanecarboxylate (trademark: EMINENCE/SumiOne, manufactured by Sumitomo Chemical Co., Ltd., hereinafter referred to as “the present insecticidal agent”), a pyrethroid insecticidal compound, was added to an OP varnish (trademark: Applaus, manufactured by Naigai Ink Mfg Co., Ltd.) and agitated together, so as to prepare an OP varnish (hereinafter referred to as “the varnish (1)”) containing 20% by weight of the present insecticidal agent and an OP varnish (hereinafter referred to as “the varnish (2)”) containing 10% by weight of the present insecticidal agent.

### 2. Formation of A Coating Layer On A Face-forming Member By Varnishing

The varnish (1) having been prepared in the above-mentioned stage 1 was used to varnish onto the entire area of “Moderatone” paper (trademark of Takeo Co., Ltd.) of 70 kg by an offset printer, so as to prepare a face-forming member “a” having a coating layer. Herein, the paper of 70 kg denotes the weight per 1000 pieces of paper each having an area of 1091 mm×788 mm. The same can be said in the following description, and a weight of paper denotes the weight per 1000 pieces of paper each having an area of 1091 mm×788 mm.

Similarly, the varnish (2) was used to varnish onto the entire area of “Moderatone” paper of 70 kg, so as to prepare a face-forming member “b” having a coating layer. Similarly, the varnish (1) was used to varnish the entire area of a bleached Kraft paper of 74 kg, so as to prepare a face-forming member “c” having a coating layer. Similarly, the varnish (2) was used to varnish the entire area of a bleached Kraft paper of 74 kg, so as to prepare a face-forming member “d” having a coating layer. These face-forming members “a” to “d” each are cut into a shape of a frame for fixation. The amount of the present insecticidal agent per one surface of each of the face-forming members “a” to “d” having been cut was about 10 mg in the member “a”, about 5 mg in the member “b”, about 7 mg in the member “c”, and about 4 mg in the member “d”. In each of the members “a” to “d”, its surface was dry and not sticky.

### 3. Manufacturing of An Insect Repellent Device

Two pieces of the face-forming members “a” and “a” having been prepared in the above-mentioned stage 2 were adhered to a frame (flat type), which has been molded by polypropylene resin, in such a manner as sandwiching the frame, so as to manufacture an insect repellent device “A”. Specifically, the coating layers of the insect repellent device “A” held the present insecticidal agent equivalent to about 10 mg per one surface (about 20 mg per both surfaces). Similarly, the face-forming members “b” and “b”were adhered to a frame in such a manner as sandwiching the frame, so as to manufacture an insect repellent device “B”. Specifically, the coating layers of the insect repellent device “B” held the present insecticidal agent equivalent to about 5 mg per one surface (about 10 mg per both surfaces). Similarly, the face-forming members “c” and “c” were adhered to a frame in such a manner as sandwiching the frame, so as to manufacture an insect repellent device “C”. Specifically, the coating layers of the insect repellent device “C” held the present insecticidal agent equivalent to about 7 mg per one surface (about 14 mg per both surfaces). Similarly, the face-forming members “d” and “d” were adhered to a frame in such a manner as sandwiching the frame, so as to manufacture an insect repellent device “D”. Specifically, the coating layers of the insect repellent device “D” held the present insecticidal agent equivalent to about 4 mg per one surface (about 8 mg per both surfaces). Similarly, the face-forming members “a” and “c” were adhered to a frame in such a manner as sandwiching the frame, so as to manufacture an insect repellent device “E”. Specifically, the coating layers of the insect repellent device “E” held the present insecticidal agent equivalent to about 17 mg per both surfaces.

### 4. Cage Test For Evaluation

The day before starting of a test, 100 females of Aedes aegypti were released in a cage covered with a nylon gauze (50 cm long, 5 cm wide, and 50 cm high), so as to be naturalized in an environment. On the day of the test, a pocket warmer that had been opened 20 minutes before starting of the test was disposed in the upper center of the cage, and the number of the Aedes attracted to the pocket warmer was counted. Next, the test was started by waving the insect repellent device “A”, which had been manufactured in the above-mentioned stage 3, in the lower half of the cage (120 back-and-forth movements per minute at a 60 degrees angle). Ten minutes later, the number of landed Aedes (LD number) and the number of knocked-down Aedes (KD number) were counted. As a result, the LD number and the KD number each counted 100, showing to have an excellent insect repellent effect. Further, upon conducting of similar tests for the insect repellent devices “B” to “F”, the LD number and the KD number thereof each counted 100, showing to have an excellent insect repellent effect for all the devices “B” to “F.” Herein, the LD number and the KD number after a control test using a blank device without holding the present insecticidal agent both counted null.

1. An insect repellent device adapted to repel insects by being held and waved by hand, comprising:
a frame; and
at least one face-forming member arranged on at least one surface of the frame,
wherein the face-forming member has at least one exposed surface exposed to atmospheric air,
the at least one exposed surface having a coating layer, and
the coating layer holding an insect controlling agent containing an active ingredient being volatilizable at normal temperature and being effective in insect-repellent.

2. The insect repellent device as defined in claim 1,
wherein the coating layer is formed by surface-protection treatment.

3. The insect repellent device as defined in claim 1,
wherein the coating layer is a varnish layer.

4. The insect repellent device as defined in claim 1,
wherein the frame has a frame body and a handle.

5. The insect repellent device as defined in claim 1,
wherein the face-forming member is made of paper.

6. The insect repellent device as defined in claim 1,
wherein the active ingredient contained in the insect controlling agent has a vapor pressure at 25 degrees centigrade by Donovan method within a range of 1.33×10⁻⁴ to 6.67×10⁻¹ Pa.

7. The insect repellent device as defined in claim 1,
wherein the active ingredient contained in the insect controlling agent is a pyrethroid compound.

8. The insect repellent device as defined in claim 1,
holding a fragrant substance containing an active ingredient being volatilizable at normal temperature.

9. The insect repellent device as defined in claim 8,
wherein the fragrant substance has a period of time of being effectively volatilizable in conformity with that of the active ingredient contained in the insect controlling agent.

10. The insect repellent device as defined in claim 1,
wherein at least the face-forming member is contained and hermetically sealed in a container made of a material impermeable to the active ingredient contained in the insect controlling agent.

11. The insect repellent device as defined in claim 1,
wherein the face-forming member is made of paper and printed in ink,
the ink holding an insect controlling agent containing an active ingredient being volatilizable at normal temperature and being effective in insect-repellent.

12. An insect repellent device adapted to repel insects by being held and waved by hand, comprising:
a frame; and
at least one face-forming member arranged on at least one surface of the frame,
wherein the face-forming member has at least one exposed surface exposed to atmospheric air,
the at least one exposed surface having a coating layer,
the coating layer holding an insect controlling agent containing an active ingredient being volatilizable at normal temperature and being effective in insect-repellent,
the active ingredient being a pyrethroid compound having a vapor pressure at 25 degrees centigrade by Donovan method within a range of 1.33×10⁻⁴ to 6.67×10⁻¹ Pa, and
the device holding the agent within a range of 1 to 1000 mg in total.

13. The insect repellent device as defined in claim 12,
wherein the coating layer is formed by surface-protection treatment.

14. The insect repellent device as defined in claim 12,
wherein the coating layer is a varnish layer.

15. The insect repellent device as defined in claim 12,
wherein the frame comprises a frame body and a handle.

16. The insect repellent device as defined in claim 12,
wherein the face-forming member is made of paper.

17. The insect repellent device as defined in claim 12,
holding a fragrant substance containing an active ingredient being volatilizable at normal temperature.

18. The insect repellent device as defined in claim 17,
wherein the fragrant substance has a period of time of being effectively volatilizable in conformity with that of the active ingredient contained in the insect controlling agent.

19. The insect repellent device as defined in claim 12,
wherein at least the face-forming member is contained and hermetically sealed in a container made of a material impermeable to the active ingredient contained in the insect controlling agent.

20. The insect repellent device as defined in claim 12,
wherein the face-forming member is made of paper and printed in ink,
the ink holding an insect controlling agent containing an active ingredient being volatilizable at normal temperature and being effective in insect-repellent.

21. An insect repellent device adapted to repel insects by being held and waved by hand, comprising:
a frame having a frame body and a handle; and
at least one face-forming member made of paper, printed in ink, and arranged on at least one surface of the frame,
wherein the face-forming member has at least one exposed surface exposed to atmospheric air,
the at least one exposed surface having a varnish layer,
the varnish layer holding an insect controlling agent containing an active ingredient being volatilizable at normal temperature and being effective in insect-repellent,
the active ingredient being a pyrethroid compound having a vapor pressure at 25 degrees centigrade by Donovan method within a range of 1.33×10⁻⁴ to 6.67×10⁻¹ Pa, the device holding the agent within a range of 1 to 1000 mg in total, and
at least the face-forming member being contained and hermetically sealed in a bag made of a material impermeable to the active ingredient contained in the agent.

22. The insect repellent device as defined in claim 21,
holding a fragrant substance containing an active ingredient being volatilizable at normal temperature.

23. The insect repellent device as defined in claim 22,
wherein the fragrant substance has a period of time of being effectively volatilizable in conformity with that of the active ingredient contained in the insect controlling agent.

24. The insect repellent device as defined in claim 23,
the ink holding an insect controlling agent containing an active ingredient being volatilizable at normal temperature and being effective in insect-repellent.

25. A method for manufacturing the insect repellent device as defined in claim 1,
wherein the coating layer is formed by application of treatment liquid to the face-forming member,
the treatment liquid containing an insect controlling agent.

26. A method for manufacturing an insect repellent device of a foldable or unfoldable fan shape constituted by a frame having a frame body and a handle, comprising the steps of:
adhering a face-forming member to the frame; and
applying a varnish to a surface of the face-forming member before or after the step of adhering the face-forming member to the frame,
the varnish containing an insect controlling agent containing an active ingredient being volatilizable at normal temperature.

27. The method as defined in claim 26,
wherein the face-forming member is made by cutting paper into a predetermined shape, and
wherein the step of applying the varnish is performed by applying the varnish containing the insect controlling agent to the paper before cutting.

28. The method as defined in claim 26,
wherein the active ingredient is a pyrethroid compound having a vapor pressure at 25 degrees centigrade by Donovan method within a range of 1.33×10⁻⁴ to 6.67×10⁻¹ Pa, and
wherein the device has a concentration of the agent and a thickness of the varnish adjusted so as to hold the agent within a range of 1 to 1000 mg in total.

29. The method as defined in claim 26,
further comprising the step of storing the device in a bag made of a material impermeable to the active ingredient contained in the agent.
